(19) United States
(12) Patent Application Publication
(10) Pub. No.: US 2023/0340222 A1
(43) Pub. Date: Oct. 26, 2023

(54) SILICONE FOAM WHICH IS AIR FOAMED AND SYNTACTIC AND ARTICLE SUCH AS A SECONDARY BATTERY PACK COMPRISING SAID FOAM

(71) Applicant: Elkem Silicones USA Corp., East Brunswick, NJ (US)

(72) Inventors: Hamp CAUDLE, Rock Hill, SC (US); Scott JACKSON, Rock Hill, SC (US); Yan MENG, Rock Hill, SC (US)

(21) Appl. No.: 18/300,750

(22) Filed: Apr. 14, 2023

Related U.S. Application Data
(60) Provisional application No. 63/332,895, filed on Apr. 20, 2022.

(51) Int. Cl. H01M 50/204; C08J 9/32; H01M 10/0525

(52) U.S. Cl. CPC C08J 9/32; H01M 10/0525; H01M 50/204; C08J 2203/22; C08J 2383/05; H01M 2220/20

(57) ABSTRACT

The invention relates to a new silicone foam which is air foamed and syntactic and to a process for manufacturing said silicone foam. The present invention also relates to an article such as a secondary battery pack comprising said silicone foam which is air foamed and syntactic and to a new recycling method comprising the steps of removing the said silicone foam from the article and then recycling or re-using components of said article.

### CROSS REFERENCE TO RELATED APPLICATION

This application claims priority to U.S. Provisional Application No. 63/332,895, filed 20 Apr. 2022 which is incorporated by reference in its entirety.

### BACKGROUND

### Field of the Invention

The invention relates to a new silicone foam which is air foamed and syntactic and to a process for manufacturing said silicone foam. The present invention also relates to an article such as a secondary battery pack comprising said silicone foam which is air foamed and syntactic and to a new recycling method comprising the steps of removing the said silicone foam from the article and then recycling or re-using components of said article.

### Description of Related Art

Silicone elastomers have attracted a great interest as cured silicones have interesting properties such as high elasticity, flexibility at low and high temperatures, high gas permeability, very low glass transition temperatures (Tg around -120° C.), very good dielectric properties and good biocompatibility.

As silicone foams can provide significant weight saving structures, in recent years considerable efforts have been invested in developing methods of introducing porosity in silicone cured materials without causing detrimental effects on their mechanical properties.

For example, new energy storage means are now used in transportation, in grid scale energy storage and in green building technologies for which thermal insulation is required. This has led to seeing a rising use of silicone foams which are chosen due to their excellent thermal insulating properties, and their good moisture resistance with a supplementary advantage of being a lightweight alternative to traditional elastomeric encapsulants and sealants.

Within this rising trend of using new energy storage means, lithium-ion battery (LIB) technology is becoming the first choice for energy storage and the most attractive battery technology due to its high energy density, high specific energy and good recharge capability.

However, there are concerns about the availability and supply of key raw materials, such as lithium and cobalt, which sustain this technology, and therefore there is an emerging need to have either rework capability or a process for recovering key components or raw materials within articles such as a battery pack comprising valuable components such as secondary battery cells.

Indeed, re-use is now seen as a positive progressive response to the shortening of product life spans, which is one of the leading factors contributing to a greater pressure on resources and manufacturing burdens.

Re-use may be defined as any operation by which products or components that are not waste are used again for the same purpose for which they were conceived. Re-use occurs before the item(s) become waste.

On the other hand, process for recovering key components for recyclability is often named “preparing for re-use” which means checking, cleaning or repairing recovery operations, by which products or components of products that have become waste are prepared so that they can be re-used without any other preprocessing.

As the global secondary battery cell consumption is anticipated to follow an exponential increase, re-use and/or recycling secondary battery cells is now becoming a major challenge for numerous industries. Therefore, materials which are used within battery pack containing secondary battery cells should allow an easy process for recovering the secondary battery cells for re-use or recycling purpose.

Furthermore, rechargeable battery cells used in secondary battery pack offer several advantages over disposable batteries, however this type of battery is not without its drawbacks. In general, most of the disadvantages associated with rechargeable batteries are due to the battery chemistries employed, as these chemistries tend to be less stable than those used in primary cells. Secondary battery cells such as lithium-ion cells tend to be more prone to thermal management issues which occur when elevated temperatures trigger heat-generating exothermic reactions, raising the temperature further and potentially triggering more deleterious reactions. During such an event, a large amount of thermal energy is rapidly released, heating the entire cell up to a temperature of 850° C. or more. Due to the increased temperature of the cell undergoing this temperature increase, the temperature of adjacent cells within the battery pack will also increase. If the temperature of these adjacent cells is allowed to increase unimpeded, they may also enter into an unacceptable state with exceedingly high temperatures within the cell, leading to a cascading effect where the initiation of temperature increases within a single cell propagate throughout the entire battery pack. As a result, power from the battery pack is interrupted and the system employing the battery pack is more likely to incur extensive collateral damage due to the scale of damage and the associated release of thermal energy. In a worst-case scenario, the amount of generated heat is great enough to lead to the combustion of the battery as well as materials in proximity to the battery.

In addition, due to the characteristics of the lithium-ion batteries, the secondary battery pack may operate within an ambient temperature range of -20° C. to 60° C. However, even when operating within this temperature range, the secondary battery pack may begin to lose its capacity or ability to charge or discharge should the ambient temperature fall below 0° C. Depending on the ambient temperature, the life cycle capacity or charge/discharge capability of the battery may be greatly reduced as the temperature stays below 0° C. Nonetheless, it may be unavoidable that the lithium-ion battery be used where the ambient temperature falls outside the optimum ambient temperature range which is between 20° C. to 25° C.

Alluding to the above, in a battery pack assembly comprising multiple secondary battery cells, significant temperature variances can occur from one cell to the next, which is detrimental to performance of the battery pack. To promote long life of the entire battery pack, the cells must be below a desired threshold temperature. To promote pack performance, the differential temperature between the cells in the secondary battery pack should be minimized. However, depending on the thermal path to ambient, different cells will reach different temperatures. Further, for the same reasons, different cells reach different temperatures during the charging process. Accordingly, if one cell is at an increased temperature with respect to the other cells, its charge or discharge efficiency will be different, and, therefore, it may charge or discharge faster than the other cells. This will lead to decline in the performance of the entire pack.

A number of approaches have been employed to either reduce the risk of thermal issues or reduce the risk of thermal propagation. These can be found for example in document US2012/0003508 which describes a battery of lithium electrochemical generators including a casing; a plurality of lithium electrochemical generators housed in the casing, each generator including a container; a rigid, flame-retardant foam with closed porosity formed of an electrically insulating material filling the space between the inner wall of the casing and the free surface of the side wall of the container of each electrochemical generator, the foam covering the free surface of the side wall of the container of each electrochemical generator over a length representing at least 25% of the height of the container. According to one embodiment, the foam consists of a material chosen from the group comprising polyurethane, epoxy, polyethylene, melamine, polyester, formophenol, polystyrene, silicone or a mixture thereof, polyurethane and the mixture of polyurethane and epoxy being preferred. The expansion of polyurethane resin for foam-form is described using the following chemical routes to obtain the foam:
a) via chemical route, i.e. the reaction of water on isocyanate producing CO₂ which will cause the polyurethane to foam;
b) via physical route, i.e. vaporization of a liquid with low boiling point under the action of heat produced by the exothermal reaction between isocyanate and the hydrogen-donor compound, or
c) via injection of air.

However, isocyanates and many other irritant gases, such as nitric oxide and aldehydes are generated during the thermal degradation of any PU based material and it exhibits an adverse effect on the respiratory system. Therefore, another technology is required to avoid such health issue.

Another efficient solution involves the use of silicone syntactic foam for thermally insulating a secondary battery pack and further minimizing the propagation of thermal runaway and is described in Pat. Application US2018223070 filed by Elkem Silicones USA Corp. In this patent application, silicone potting products provided as silicone syntactic foams find great usage.

Although the above solutions for thermally insulating articles such as secondary battery packs may find great usage, there is still a need for a new lightweight thermal insulating material which also allows an easy process for separating it from said article for re-use of recycling purposes of key components such as secondary battery cells.

### SUMMARY

In this context, one of the essential objectives of the present invention is to provide a new silicone foam and its process of manufacture.

Another essential objective of the invention is to provide an article such as a secondary battery pack comprising the silicone foam according to the invention.

Finally, the last essential objective of the invention is to provide a new recycling method to allow recycling or re-using the article and/or some components of said article.

Before the subject disclosure is further described, it is to be understood that the disclosure is not limited to the particular embodiments of the disclosure described below, as variations of the particular embodiments may be made and still fall within the scope of the appended claims. It is also to be understood that the terminology employed is for the purpose of describing particular embodiments and is not intended to be limiting. Instead, the scope of the present disclosure will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this disclosure belongs.

As used herein, the term “alkenyl” is understood to mean an unsaturated, linear or branched hydrocarbon chain, substituted or not, having at least one olefinic double bond, and more preferably a single double bond. Preferably, the “alkenyl” group has 2 to 8 carbon atoms and better still 2 to 6. This hydrocarbon chain optionally includes at least one heteroatom such as O, N, S. Preferred examples of “alkenyl” groups are vinyl, allyl and homoallyl groups, vinyl being particularly preferred.

As used herein, “alkyl” denotes a saturated, linear or branched hydrocarbon chain, possibly substituted (e.g. with one or more alkyls), with preferably 1 to 10 carbon atoms, for example 1 to 8 carbon atoms and better still 1 to 4 carbon atoms. Examples of alkyl groups are notably methyl, ethyl, isopropyl, n-propyl, tert-butyl, isobutyl, n-butyl, n-pentyl, isoamyl and 1,1-dimethylpropyl.

### BRIEF DESCRIPTION OF THE DRAWINGS

FIGS. 1-5 depict embodiments as described herein.

### DETAILED DESCRIPTION OF A PREFERRED EMBODIMENT

All these objectives, among others, are achieved by the present invention, which relates to a method for preparing a silicone foam which is air foamed and syntactic comprising the following steps:
a) preparing a curable silicone composition X comprising hollow microspheres D1, and
b) allowing the curable silicone composition X to cure under a reduced atmospheric pressure to obtain a silicone foam which is air foamed and syntactic.

As a result of diligent research, the inventors of the present invention found that it was possible to prepare a silicone syntactic foam which is also air-foamed without having to use a chemical foaming agent, a mechanical foaming process or a physical foaming process. Adding hollow microspheres D1 to a curable silicone composition and performing the curing step under a reduced atmospheric pressure yielded surprisingly to a silicone syntactic foam which is also air foamed. The produced foam has the advantage of having a lower thermal conductivity compared to a standard silicone syntactic foam. The produced foam according to the invention exhibits a homogeneous cell size distribution and a good foam structure.

Thus, the new silicone foam which is air foamed and syntactic, has low thermal conductivity property and can offer great alternative options when considering new classes of materials, for instance, to realize reductions in fuel consumption and CO₂ emissions in transportation as well as to manage safety in energy storage articles used in transportation or in net-zero energy building.

The process according to the invention has the advantage of avoiding some hurdles which are encountered for example in foam extrusion process, which is a continuous process, involving physical foaming by using CO₂ as a blowing agent. Indeed, in this physical foaming process, a curable polymeric composition is first saturated with CO₂ at a few to several hundreds of bars so that foaming is induced by a rapid depressurization step that is typically followed by an increase in temperature. This results in an oversaturation of the dissolved CO₂ in the curable polymeric composition gas mixture leading to cell nucleation followed by rapid cell expansion. Although this technique is thoroughly used, there are some remaining challenges which are difficult to control such as CO₂ solubility, CO₂ diffusivity, and foaming temperature. Therefore, the new process according to the invention is addressing these rising needs for simplification of processes used in the prior art.

By “a silicone syntactic foam which is also air-foamed” it is meant a cured silicone gel or cured silicone material as a binder comprising pre-formed hollow microspheres and air cavities created by the new foaming process according to the invention.

Without being bound by the theory, the hollow microspheres are in the form of a powder which may favor air trapping during compounding and may cause native air bubbles to occur within the polymeric matrix under construction. The hollow microspheres may have a stabilizing effect upon the native air bubbles and may enhance the nucleation efficiency. Indeed, frequently used strategies to increase the nucleated cell density rely for example in physical blowing processes on increasing the physical blowing agent saturation pressure and/or increasing the pressure release rate. Therefore, the process according to the invention is much simpler and exhibits clear advantages over known blowing processes of the prior art.

The process according to the invention allows to prepare a foam which is lighter than a silicone syntactic foam and which exhibits improved thermal insulating properties. Therefore, it can be used within an article such as a secondary battery pack for thermal insulating secondary battery cells and have another advantage of being more easily removable compared to a silicone syntactic foam so avoiding damages of the battery cells.

In a preferred embodiment, the hollow microspheres D1 are hollow glass microspheres D, and more preferably are hollow borosilicate glass microspheres.

In a preferred embodiment, the reduced atmospheric pressure applied is below 700 mbar, preferably from 700 to 100 mbar, and even more preferably from 530 to 150 mbar.

In another embodiment, the reduced pressure applied is below 700 mbar, from 700 to 50 mbar, from 700 to 140 mbar, from 530 to 140 mbar, from 360 to 140 mbar, from 190 to 140 mbar, below 530 mbar or below 200 mbar.

In another embodiment, the reduced atmospheric pressure applied is from 100 to 700 mbar, from 100 to 600 mbar, from 100 to 550 mbar, from 100 to 500 mbar, from 100 to 450 mbar, from 100 to 400 mbar, from 100 to 350 mbar, from 100 to 300 mbar, from 100 to 250 mbar, from 100 to 200 mbar, from 150 to 200 mbar, from 150 to 250 mbar, from 150 to 300 mbar, from 150 to 350 mbar, from 150 to 400 mbar, from 150 to 500 mbar, from 150 to 550 mbar, from 150 to 600 mbar, from 150 to 650 mbar and from 150 to 700 mbar.

In another preferred embodiment, the reduced atmospheric pressure is applied before the curable silicone composition X is fully cured and at a time which is at least 10% of gel time of the curable silicone composition X, preferably at a time which is at least 30% of gel time of the curable silicone composition X, more preferably at a time which is from 30% to 70% of gel time of the curable silicone composition X, and even more preferably at a time which is from 45% to 65% of gel time of the curable silicone composition X.

The gel time corresponds to the time for the reaction mixture to gel and is measured at room temperature (20° C.).

In another preferred embodiment, for 100 parts by weight of the curable silicone composition X it further comprises from 1 part to 60 parts by weight, preferably from 5 parts to 40 parts by weight, most preferably from 5 parts to 30 parts by weight and even more preferably from 5 parts to 20 parts by weight of hollow microspheres D1.

As examples of suitable hollow microspheres D1 it can be cited hollow glass microspheres or hollow ceramic microspheres.

Hollow ceramic microspheres also referred to as cenospheres are lightweight, inert, hollow sphere filled with inert air or gas, typically produced as a byproduct of coal combustion at thermal power plants. They are made largely of silica and alumina. The color of cenospheres varies from gray to almost white and their density is about 0.4 to 0.8 g/cm³. It flows like a liquid, with the appearance of a powder. Suitable cenospheres are not surface-treated or are surface-treated for example with a silane-based coupling agent such as one or more of 3-aminopropyltriethoxysilane, gamma-glycidoxypropyltrimethoxysilane, gamma-(methacryloyloxy) propyltrimethoxysilane, 3-aminopropyltrimethoxysilane, 4-aminopropylmethyldimethoxysilane or 3-aminopropylmethyldiethoxysilane.

Hollow glass microspheres are sometimes termed “hollow glass beads” or “hollow glass bubbles” and are employed in the invention, and function to reduce the density of the silicone foam and to play a key role in the air foaming process. Hollow Glass microspheres are small hollow spheres of hardened silica (glass) that can vary in size and density depending on the grade. They have a shell that is thick enough to maintain structural rigidity. Due to their hollow nature, they are very lightweight, with a density that varies with size and wall thickness. In bulk they appear as a white powder. The main differences between grades are in their size, strength and density, with the strength of the microspheres being expressed in terms of their average isostatic crushing strength.

According to an embodiment, hollow glass beads are hollow borosilicate glass microspheres.

According to an embodiment, the hollow glass microspheres D have a true density ranging from 0.10 gram per cubic centimeter (g/cc) to 0.75 gram per cubic centimeter (g/cc).

The terms “true density” is the quotient obtained by dividing the mass of a sample of hollow glass microspheres by the true volume of that mass of glass bubbles as measured by a gas pycnometer. The “true volume” is the aggregate total volume of the glass bubbles, not the bulk volume.

According to a preferred embodiment, hollow glass microspheres are chosen from:
1) 3M™ Glass Bubbles Floated Series (A16/500, G18, A20/1000, H20/1000, D32/4500 and H50/10,000EPX glass bubbles products) and 3M™ Glass Bubbles Series (such as but not limited to K1, K11, K15, S15, S22, K20, K25, S32, S35, K37, XLD3000, S38, S38HS, S38XHS, K46, K42HS, S42XHS, S60, S60HS, iM16K, iM30K, A16/500, A20/1000, H20/1000, D32/4500, H50/10,000 EPX, HGS2000, HGS3000, HGS4K28, HGS4000, HGS5000, HGS6000, HGS10000, HGS8000X, HGS18000, HGS19K46 glass bubbles products) sold by 3 M Company. Said glass bubbles exhibit various crush strengths ranging from 1.72 megapascal (250 psi) to 186.15 Megapascals (27,000 psi) at which ten percent by volume of the first plurality of glass bubbles collapses. They exhibit true densities ranging from around 0.11 g/cc to around 0.60 g/cc. Other glass bubbles sold by 3 M such as 3M™ Glass Bubbles - Floated Series, 3M™ Glass Bubbles - HGS Series and 3M™ Glass Bubbles with Surface Treatment could also be used according to the invention; and
2) Hollow glass microspheres sold by Potters Industries LLC under the tradename SPHERICEL™ (products such as: 110P8, 60P18, 34P30, and 25P45) which exhibit bulk densities ranging from around 0.14 g/cc to around 0.49 g/cc or under the tradename Q-CeI™ Lightweight (products such as 6014, 6019, 7019, 6019S, 5020, 5020FPS, 7023, 7028, 6036, 7037, 7040S, 6042S, 6048, 5070S) which exhibit bulk densities ranging from around 0.08 g/cc to around 0.42 g/cc.

The curable silicone composition X is a liquid precursor which after curing yields to a binder such as a silicone gel or a silicone elastomer (sometimes also referred as “silicone rubber”). Suitable curable silicone compositions X maybe composed of three to four essential ingredients. These ingredients are (i) one or more reactive silicone polymer, (ii) eventually one or more filler(s), (iii) a crosslinking agent, and (iv) a catalyst.

The cured silicone binder may be obtained by curing either an addition curing type organopolysiloxane composition, a peroxide curing type organopolysiloxane composition or a condensation type organopolysiloxane composition.

An example of a peroxide curing type organopolysiloxane composition according to the invention is preferably defined as primarily comprising:
(1) for 100 parts by weight of an organopolysiloxane having at least two alkenyl groups attached to silicon atoms in a molecule,
(2) from 0.01 to 10 parts by weight, preferably from 0.1 to 5 parts by weight of an organic peroxide which will generate free radicals at elevated temperatures, initiating a crosslinking reaction, and
(3) from 0.1 to 60 parts by weigh, preferably from 5 to 40 parts by weight, and most preferably from 5 to 30 parts by weight of hollow microspheres D1.

The organopolysiloxane having at least two alkenyl groups attached to silicon atoms in a molecule have the same chemical structure as those used for polyaddition curable composition but may have higher number of siloxyl units and hence higher viscosities. Such polymers may contain from 0 to 4%, preferably from 0.01 to 3%, by weight, of a vinyl group. When these polyorganosiloxane polymers have viscosities at 25° C. of up to to 1,000,000 mPa·s, they are called oils, but when their viscosity is greater than 1,000,000 mPa·s they are called gums.

Suitable organic peroxides include peroxy ketals, hydroperoxides, dialkyl peroxides, diacyl peroxides, peroxy esters, and peroxy dicarbonates. benzoyl peroxide, bis(p-chlorobenzoyl) peroxide, bis(2,4-dichlorobenzoyl) peroxide, dicumyl peroxide, di-t-butyl peroxide, 2,5-dimethyl-2,5-di(t-butylperoxy)hexane, t-butyl-perbenzoate, t-butylcumyl peroxide, the halogenated derivatives of the above-mentioned peroxides such as for example bis(2,4-dichlorobenzoyl) peroxide, 1,6-bis(p-toluoylperoxycarbonyloxy)hexane, 1,6-bis(benzoylperoxy-carbonyloxy)hexane, 1,6-bis(p-toluoylperoxycarbonyloxy)butane and 1,6-bis(2,4-dimethylbenzoylp eroxycarbonyloxy)hexane.

An example of a condensation curing type organopolysiloxane composition according to the invention is preferably defined as primarily comprising:
(1) for 100 parts by weight of an organopolysiloxane having at least two hydroxyl end groups, optionally prefunctionalized with a silane so as to have hydrolyzable groups,
(2) from 0.1 to 50 parts by weight, preferably from 1 to 30 parts by weight and even more preferably from 1 to 20 parts by weight of at least one crosslinking agent,
(3) from 1 part to 60 parts by weight, preferably from 5 parts to 40 parts by weight, most preferably from 5 parts to 30 parts by weight and even more preferably from 5 parts to 20 parts by weight of hollow glass microspheres of hollow microspheres D1. and
(4) a catalytic amount of a condensation catalyst.

A curable silicone composition used in the present invention which crosslinks and cures via condensation reaction is well known and is commercially available. Such compositions may be packaged as a single component that is to say the compositions are packaged in a single package, and stable during storage, in the absence of moisture, and can be cured in the presence of moisture, in particular moisture provided by the ambient air or by water generated within the base during the use thereof. Apart from single-component packaging, use may be made of two-component packaging (the catalyst is separated from the organopolysiloxane have hydroxyl end-groups), that is to say compositions are packaged in two distinct packages, which cure as soon as the two components are mixed.

The organopolysiloxane having at least two hydroxyl end groups is preferably an α,ω-dihydroxypolydiorganosiloxane polymer, with a viscosity ranging from 50 to 1,000,000 mPa·s at 25° C. and may also be functionalized at its ends by hydrolyzable radicals obtained by condensation of a precursor bearing hydroxyl functional groups with a crosslinking silane bearing hydrolyzable radicals. The crosslinking agent is preferably an organosilicon compound bearing more than two hydrolyzable groups bonded to the silicon atoms per molecule. As the crosslinking agent mention may be made of:
silanes of the following general formula: R¹ₖSi(OR²)₍₄₋ₖ₎ in which the symbols R², which are identical or different, represent alkyl radicals having from 1 to 8 carbon atoms, such as methyl, ethyl, propyl, butyl, pentyl or 2-ethylhexyl radicals, C₃-C₆ oxyalkylene radicals, the symbol R₁ represents a linear or branched, saturated or unsaturated, aliphatic hydrocarbon-based group, a saturated or unsaturated and/or aromatic, monocyclic or polycyclic carbocyclic group, and k is equal to 0, 1 or 2; and
the partial hydrolysis products of this type of silane.

The crosslinking agents are products that are available on the silicones market; furthermore, their uses in room-temperature curing compositions is known and are described in French patents FR-A-1 126 411, FR-A-1 179 969, FR-A-1 189 216, FR-A-1 198 749, FR-A-1 248 826, FR-A-1 314 649. FR-A-1 423 477, FR-A-1 432 799 and FR-A-2 067 636.

Preference is more particularly given, among the crosslinking agents to alkyltrialkoxysilanes, alkyl silicates and alkyl polysilicates, in which the organic radicals are alkyl radicals having from 1 to 4 carbon atoms.

As other examples of crosslinking agents that may be used, mention is more particularly made of the following silanes:
propyltrimethoxysilane;
methyltrimethoxysilane;
ethyltrimethoxysilane;
vinyltriethoxysilane;
methyltriethoxysilane;
vinyltriethoxysilane;
propyltriethoxysilane;
tetraethoxysilane;
tetrapropoxysilane;
1,2-bis(trimethoxysilyl)ethane;
1,2-bis(triethoxysilyl)ethane; and
tetraisopropoxysilane,
CH₃Si(OCH₃)₃; C₂H₅Si(OC₂H₅)₃; C₂H₅Si(OCH₃)₃
CH₂=CHSi(OCH₃)₃; CH₂=CHSi(OCH₂CH₂OCH₃)₃
C₆H₅Si(OCH₃)₃; [CH₃][OCH(CH₃)CH₂OCH₃]Si[OCH₃]₂
Si(OCH₃)₄; Si(OC₂H₅)₄; Si(OCH₂CH₂CH₃)₄; Si(OCH₂CH₂CH₂CH₃)₄
Si(OC₂H₄OCH₃)₄; CH₃Si(OC₂H₄OCH₃)₃; ClCH₂Si(OC₂H₅)₃.

As other examples of crosslinking agent, mention may be made of ethyl polysilicate or n-propyl polysilicate.

As example of an addition curing type organopolysiloxane composition suitable for the invention, it includes composition comprising:
(1) at least one organopolysiloxane A having at least two silicon-bonded alkenyl groups per molecule, linear or branched and having from 2 to 8 carbon atoms,
(2) at least one organohydrogensiloxane B having at least two silicon-bonded hydrogen atoms per molecule and preferably at least three silicon-bonded hydrogen atoms per molecule;
(3) at least one hydrosilylation catalyst C,
(4) hollow microspheres D1, and preferably hollow glass microspheres D,
(5) optionally at least one filler E,
(6) optionally at least one cure rate controller G which slows the curing rate,
(7) optionally at least one additive H, and
(8) optionally at least one silicone resin I.

In a preferred embodiment, the organohydrogensiloxane B is a mixture of at least one silicon compound CE comprising two telechelic hydrogen atoms bonded to silicon per molecule with no pendent hydrogen atoms bonded to silicon per molecule and at least one silicon compound XL comprising at least three hydrogen atoms bonded to silicon per molecule,

The term “alkenyl” means an acyclic, branched or unbranched, monovalent hydrocarbon group having one or more carbon-carbon double bonds. Alkenyl is exemplified by, but not limited to, vinyl, allyl, methallyl, propenyl, and hexenyl. Alkenyl groups may have preferably from 2 to 8 carbon atoms.

As another preferred embodiment, the curable silicone composition is an addition curing type organopolysiloxane composition and is defined as comprising:
a) for 100 parts by weight of at least one organopolysiloxane A having at least two silicon-bonded alkenyl groups per molecule,
b) from 0.1 to 50 parts by weight of at least one organohydrogensiloxane B having at least two silicon-bonded hydrogen atoms per molecule (i.e., SiH groups and preferably at least three silicon-bonded hydrogen atoms per molecule,
c) from 1 to 60 parts by weight, preferably from 5 parts to 40 parts by weight, most preferably from 5 parts to 30 parts by weight and even more preferably from 5 parts to 20 parts by weight of hollow microspheres D1.
d) a catalytic amount of an addition reaction catalyst C,
e) from 0 to 50 parts by weight of at least one filler E,
f) from 0 to 20 parts by weight of at least one additive H,
g) eventually an effective amount of at least one cure rate controller G which slows the curing rate of the curable silicone composition, and
i) from 0 to 50 parts by weight of at least one silicone resin I.

This embodiment offers several advantages over one-part systems (condensation type organopolysiloxane compositions), especially in production environments. Since it is the catalyst and not moisture, as in the case of a condensation curing silicone, that causes the cure, they have no issue with section thickness. Indeed, they are advantageously used for applications such as potting, encapsulating and large castings. Addition curing type organopolysiloxane compositions do not release reaction by-products so they can cure in closed environments. Their cure can also be greatly accelerated by heat curing however curing can be easily obtained without the need of heat, so at ambient temperature 20° C. (+/-5° C.), by adjusting the level of inhibitor and/or catalyst which is a great advantage compared to peroxide curing which needs temperature above 90° C.

According to another preferred embodiment, the curable silicone composition X comprises:
a) at least one organopolysiloxane A of the following formula:

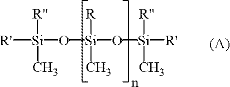

in which:
   R and R″, are chosen independently of one another from the group consisting of C₁ to C₃₀ hydrocarbon radical, and preferably R and R are an alkyl group chosen from the group consisting of methyl, ethyl, propyl, trifluoropropyl, and phenyl, and most preferably R is a methyl group,
   R′ is a C₁ to C₂₀ alkenyl radical, and preferably R′ is chosen from the group consisting of vinyl, allyl, hexenyl, decenyl and tetradecenyl, and most preferably R′ is a vinyl radical, and
   n is an integer having a value from 1 to 1000, or from 1 to 500, or from 10 to 500, or from 10 to 400, or from 10 to 350, or from 10 to 300, or from 10 to 250, and preferably from 5 to 100,
b) at least one silicon compound B comprising at least two hydrogen atoms bonded to silicon per molecule and preferably at least three hydrogen atoms bonded silicon per molecule, and most preferably a mixture of two silicon compounds B one comprising two telechelic hydrogen atoms bonded to silicon per molecule with no pendent hydrogen atoms bonded to silicon per molecule (compound CE) and the other comprising at least three hydrogen atoms bonded to silicon per molecule (compound XL) and preferably at least three hydrogen atoms bonded to silicon per molecule,
c) an effective amount of hydrosilylation catalyst C, and preferably a platinum based hydrosilylation catalyst C, and
d) hollow microspheres D1, and preferably hollow borosilicate glass microspheres.
e) optionally at least one filler E,
f) optionally at least one additive H,
g) optionally at least one cure rate controller G which slows the curing rate of the silicone composition, and
i) optionally at least one silicone resin I.

According to the above embodiment, the curable liquid silicone composition of the invention comprises at least one alkenyl group-containing organopolysiloxane A having two silicon-bonded alkenyl groups per molecule. In some embodiments, the curable liquid silicone composition of the invention comprises more than one alkenyl group-containing organopolysiloxane A having two silicon-boned alkenyl groups per molecule. For example, the curable liquid silicone composition of the invention may comprise two alkenyl group-containing organopolysiloxanes A (A1 and A2) each having two silicon-bonded alkenyl groups per molecule.

In some embodiments, the at least one alkenyl group-containing organopolysiloxane A comprises:
two siloxy units of formula (A-1):

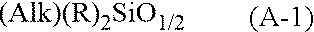

in which: the symbol “Alk” represents a C₂ to C₂₀ alkenyl group, such as a vinyl, allyl, hexenyl, decenyl, or tetradecenyl group, preferably a vinyl group hydrogen atom, and the symbol R represents a C₁ to C₂₀ alkyl group, such as a methyl, ethyl, propyl, trifluoropropyl, or aryl group, preferably a methyl group, and
other siloxy units of formula (A-2):

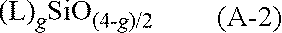

in which the symbol L represents a C₁ to C₂₀ alkyl group, such as a methyl, ethyl, propyl, trifluoropropyl, or aryl group, preferably a methyl group, and the symbol g is equal to 0, 1, 2 or 3, in which each instance of L can be the same or different.

In some preferred embodiments, the at least one alkenyl group-containing organopolysiloxane A is of the following formula (1):

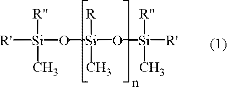

in which:
n is an integer having a value from 1 to 1000, or from 1 to 500, or from 10 to 500, or from 10 to 400, or from 10 to 350, or from 10 to 300, or from 10 to 250, and preferably from 5 to 100,
R is a C₁ to C₂₀ alkyl group, such as a methyl, ethyl, propyl, trifluoropropyl, or aryl group, preferably a methyl group,
R′ is a C₂ to C₂₀ alkenyl group, such as a vinyl, allyl, hexenyl, decenyl, or tetradecenyl group, preferably a vinyl group, and
R″ is a C₁ to C₂₀ alkyl group, such as a methyl, ethyl, propyl, trifluoropropyl, or aryl group, preferably a methyl group.

In a preferred embodiment, the at least one alkenyl group-containing organopolysiloxane A is one or more α,ω-(vinyldimethylsilyl)polydimethylsiloxane(s), more preferably, one or more linear α,ω -(vinyldimethylsilyl)polydimethylsiloxane(s).

All the viscosities under consideration in the present specification correspond to a dynamic viscosity magnitude that is measured, in a manner known per se, at 25° C., with a machine of Brookfield type. As regards to fluid products, the viscosity under consideration in the present specification is the dynamic viscosity at 25° C., known as the “Newtonian” viscosity, i.e., the dynamic viscosity that is measured, in a manner known per se, at a sufficiently low shear rate gradient so that the viscosity measured is independent of the rate gradient.

In some embodiments, the viscosity of the at least one alkenyl group-containing organopolysiloxane A is between about 50 to about 100,000 mPa.s, between about 5 to 100,000 mPa.s, between about 100 to about 80,000 mPa.s., between about 100 to about 65,000 mPa.s, from 5 mPa.s to about 5,500 mPa.s, from about 100 to about 40,000 mPa.s, from about 100 to about 35,000 mPa.s, from about 100 to about 30,000 mPa.s, r from about 100 to about 25,000 mPa.s, from about 100 to about 20,000 mPa.s, from 100 to about 15,000 mPa.s, from 5 to about 15,000 mPa.s, from 5 to about 10,000 mPa.s or from 5 to 5,000 mPa.s.

In some embodiments, the molecular weight of the at least one alkenyl group-containing organopolysiloxane A is between about 1,000 g/mol to about 80,000 g/mol, or between about 10,000 g/mol to about 70,000 g/mol or between 10,000 g/mol to about 40,000 g/mol, or between 10,000 g/mol to about 35,000 g/mol or between 10,000 g/mol to about 30,000 g/mol.

According to a preferred embodiment organopolysiloxane A is chosen from the group of dimethylpolysiloxanes containing dimethylvinylsilyl end groups.

A suitable example of a silicon compound B is an organohydrogenpolysiloxane comprising from 10 to 500 silicon atoms within each molecule, preferably from 10 to 250 silicon atoms within each molecule. It can be included in the curable liquid silicone composition in an amount from about 0.01% to about 10%, preferably from about 0.05% to about 5%, preferably from about 0.1% to about 4% by weight of the total composition.

In some embodiments, the molecular weight of the silicon compound B is from about 135 g/mol to about 20,000 g/mol, from about 400 g/mol to about 15,000 g/mol, from about 420 g/mol to about 13,000 g/mol, from about 425 g/mol to about 20,000 g/mol, from about 425 g/mol to about 15,000 g/mol or from about 425 g/mol to about 12,500 g/mol.

In a preferred embodiment, the silicon compound B is a mixture of:
at least one silicon compounds B comprising two telechelic hydrogen atoms bonded to silicon per molecule with no pendent hydrogen atoms bonded to silicon per molecule (namely compound CE), and
at least one silicon compounds B comprising at least three hydrogen atoms bonded to silicon per molecule (namely compound XL).

In some embodiments, the organosilicon crosslinker XL containing at least 3 silicon-bonded hydrogen atoms (silicon hydride or SiH) per molecule/polymer is an organohydrogenpolysiloxane comprising from 0.45% to 40% of SiH by weight, more preferably between 0.5% to 35% of SiH by weight, more preferably between 0.5% to 15% of SiH by weight or between 5% to 12% of SiH by weight.

In some embodiments, the organosilicon crosslinker XL comprises:
(i) at least 3 siloxy units of formula (XL-1) which may be identical or different:

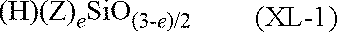

in which:
   the symbol H represents a hydrogen atom,
   the symbol Z represents an alkyl having from 1 to 8 carbon atoms inclusive, and
   the symbol e is equal to 0, 1 or 2, preferably e is equal to 1 or 2; and
(ii) at least one, and preferably from 1 to 550 of siloxy unit(s) of formula (XL-2):

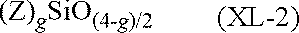

in which:
- the symbol Z represents an alkyl having from 1 to 8 carbon atoms inclusive, and
- the symbol g is equal to 0, 1, 2 or 3, preferably g is equal to 2;
   in which Z in XL-1 and XL-2 can be the same or different.

In some embodiments, the symbol Z is selected from methyl, ethyl, propyl and 3,3,3-trifluoropropyl groups, cycloalkyl groups, and aryl groups. In some embodiments, Z is a cycloalkyl group selected from cyclohexyl, cycloheptyl, and cyclooctyl groups. In other embodiments, Z is an aryl group selected from the group consisting of xylyl, tolyl, and phenyl groups. In other embodiments, Z is a methyl group.

In a preferred embodiment, the symbol “e” in XL-1 is 1 or 2. In a preferred embodiment, the symbol “g” in XL-2 is 2. In a preferred embodiment, the organosilicon crosslinker XL comprises from 3 to 60 siloxy units of formula (XL-1) and from 1 to 250 siloxy unit(s) of formula (XL-2).

In some embodiments, the organosilicon crosslinker XL comprises from 3 to 60 siloxy units of formula (XL-1) and from 1 to 250 siloxy unit(s) of formula (XL-2).

The viscosity at 25° C. of said the organosilicon crosslinker XL is from about 1 mPa.s to 10,000 mPa.s, from about 5 mPa.s to about 5,000 mPa.s, from about 5 mPa.s to about 4,000 mPa.s, from about 5 mPa.s to about 3,500 mPa.s, from about 5 to about 2,000 mPa.s, from about 5 mPa.s to about 1,500 mPa.s, from about 5 mPa.s to about 1,000 mPa.s, from about 5 mPa.s to about 500 mPa.s, from about 5 mPa.s to about 350 mPa.s, from about 5 mPa.s to about 150 mPa.s or from about 5 mPa.s to about 100 mPa.s.

The curable liquid silicone composition of the invention may further comprise at least one diorganohydrogensiloxy-terminated polydiorganosiloxane chain extender CE. The at least one diorganohydrogensiloxy-terminated polydiorganosiloxane chain extender CE can be included in the curable liquid silicone composition in an amount from about 0.1% to about 20%, preferably from about 0.5% to about 15%, preferably from about 0.5% to about 10% by weight of the total composition.

In some embodiments, the diorganohydrogensiloxy-terminated polydiorganosiloxane CE is of the following formula (2):

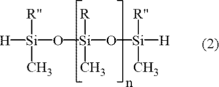

in which:
R and R″ are independently a C₁ to C₂₀ alkyl group, preferably R and R″ are independently chosen from the group consisting of: methyl, ethyl, propyl, trifluoropropyl and aryl, and most preferably R and R″ are methyl, and
n is an integer ranging from 1 to 500, preferably from 2 to 100, and more preferably from 3 to 50 or from 5 to 20.

In some embodiments, the viscosity of the at least one diorganohydrogensiloxy-terminated polydiorganosiloxane CE is from about 1 to about 500 mPa.s., from about 2 to about 100 mPa.s., from about 4 to about 50 mPa.s or from about 5 to about 25 mPa.s or from about 5 to about 20 mPa.s.

In some embodiments, the molecular weight of the at least one diorganohydrogensiloxy- terminated polydiorganosiloxane CE is between about 100 g/mol to about 5,000 g/mol, preferably between about 250 g/mol to about 2,500 g/mol, or between about 250 g/mol to about 1,500 g/mol, and more preferably from about 500 g/mol to about 1,000 g/mol.

In some embodiments, the diorganohydrogensiloxy-terminated polydiorganosiloxane CE is of the following formula (2):

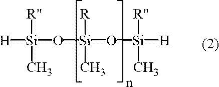

in which:
R and R″ are independent and are selected from a C₁ to C₂₀ alkyl group, and
n is an integer ranging from 1 to 500. preferably n is an integer ranging from 2 to 100, more preferably n is an integer ranging from 3 to 50 or from 3 to 20.

In some embodiments, R and R″ are independently selected from methyl, ethyl, propyl, trifluoropropyl and phenyl. Preferably, R and R″ are methyl.

In another embodiment, the diorganohydrogensiloxy- terminated polydiorganosiloxane CE has a weight ratio of the silicon chain extender B1 to the silicon crosslinker XL is from about 2:1 to about 30:1, from about 2:1 to about 20:1, from about 2:1 to about 15:1, is from about 5:1 to about 20:1, from about 5:1 to about 15:1, from about 5:1 to about 15:1 or from 6:1 to about 15:1.

According to another preferred embodiment:
the viscosity at 25° C. of said organopolysiloxane A is from about 5 mPa.s to 60,000 mPa.s, from about 5 mPa.s to about 50,000 mPa.s, from about 5 to about 40,000 mPa.s, from about 5 to about 35,000 mPa.s, from about 5 to about 30,000 mPa.s, from about 5 to about 25,000 mPa.s, from about 5 to about 20,000 mPa.s, from about 5 to about 15,000 mPa.s, from about 5 to about 10,000 mPa.s, from about 5 to about 5,000 mPa.s or from about 5 to about 3,500 mPa.s;
the viscosity at 25° C. of said silicon compound CE comprising two telechelic hydrogen atoms bonded to silicon per molecule with no pendent hydrogen atoms bonded to silicon per molecule is from about 1 to about 500 mPa.s., from about 2 to about 100 mPa.s., from about 4 to about 50 mPa.s, from about 5 to about 25 mPa.s or from about 5 to about 20 mPa.s, and
the viscosity at 25° C. of said silicon compound XL comprising at least three hydrogen atoms bonded to silicon per molecule is between 5 and 2000 mPa.s.

In a preferred embodiment, the components of the curable silicone composition X are chosen so that its viscosity is from about 100 mPa.s to about 300,000 mPa.s, from about 500 mPa.s. to about 100,00 mPa.s, and most preferably between 500 mPa.s to 10000 mPa.s., from about 500 mPa.s to about 80,000 mPa.s, from about 100 mPa.s to about 20,000 mPa.s, from about 100 mPa.s to about 15,000 mPa.s, from about 100 mPa.s to about 10,000 mPa.s, from 500 mPa.s to about 10,000 mPa.s, from about 500 mPa.s to about 5000 Pa.s, from about 500 mPa.s to about 3,500 mPa.s or from about 500 mPa.s to 2500 mPa.s.

According another preferred embodiment, the viscosities at 25° C. of said organopolysiloxane A and said silicon compound(s) B comprising at least two hydrogen atoms bonded to silicon per molecule are chosen so that the viscosity at 25° C. of the addition curing type organopolysiloxane composition X is between 500 mPa-s and 300,000 mPa-s, from about 500 mPa.s. to about 100,00 mPa.s, and even more preferably from about 500 mPa.s to about 80,000 mPa.s, so that it can be injected into the battery module casing 102. If the option of pouring the composition within the battery module casing 102 is chosen, then the components of said addition curing type organopolysiloxane composition X are chosen so that its viscosity is from about 100 mPa.s to about 20,000 mPa.s, from about 100 mPa.s to about 15,000 mPa.s, from about 100 mPa.s to about 10,000 mPa.s, from 500 mPa.s to about 10,000 mPa.s, from about 500 mPa.s to about 5000 Pa.s, from about 500 mPa.s to about 3,500 mPa.s or from about 500 mPa.s to 2500 mPa.s.

In another preferred embodiment, wherein, upon mixing of from about 5% to about 25% by weight or from about 5% to about 20% by weight of the hollow microspheres D1 with the other components of the addition curing type organopolysiloxane composition X, the said composition X has a viscosity at 25° C. from about 500 mPa·s and about 5,000 mPa·s and is capable of filling a container such as a casing of a secondary battery module or a secondary battery pack.

Examples of hydrosilylation catalysts C are hydrosilylation catalysts such as Karstedt’s catalyst shown in U.S. Pat. No. 3,715,334 or other platinum or rhodium catalysts known to those in the art, and also including microencapsulated hydrosilylation catalysts for example those known in the art such as seen in U.S. Pat. No. 5009957. However, hydrosilylation catalysts pertinent to this invention can contain at least one of the following elements: Pt, Rh, Ru, Pd, Ni, e.g. Raney Nickel, and their combinations. The catalyst is optionally coupled to an inert or active support. Examples of preferred catalysts which can be used include platinum type catalysts such as chloroplatinic acid, alcohol solutions of chloroplatinic acid, complexes of platinum and olefins, complexes of platinum and 1,3-divinyl-1,1,3,3-tetramethyldisiloxane and powders on which platinum is supported, etc. The platinum catalysts are fully described in the literature. Mention may in particular be made of the complexes of platinum and of an organic product described in U.S. Pat. Nos. 3,159,601, 3,159,602 and 3,220,972 and European Patents EP-A-057,459, EP-188,978 and EP-A-190,530 and the complexes of platinum and of vinylated organopolysiloxane described in US. Pat. Nos. 3,419,593, 3,715,334, 3,377,432, 3,814,730, and 3,775,452, to Karstedt. In particular, platinum type catalysts are especially desirable.

The hydrosilylation reaction catalyst C can be added in a catalytic quantity (effective amount). The content of the hydrosilylation reaction catalyst is not particularly limited as long as there is a quantity sufficient to promote the curing of the present composition. However, relative to the organopolysiloxane A component, it is preferable that the hydrosilylation reaction catalyst is comprised at a quantity whereby the amount of the metal atoms is by mass within the range of 0.01 to 500 ppm, 0.01 to 100 ppm or 0.01 to 50 ppm.

The composition may include one or more fillers E which may optionally be surface treated with a treating agent such as a fatty acid or a fatty acid ester such as a stearate, or with organosilanes, organosiloxanes, or organosilazanes such as hexamethyl disilazane or short chain siloxane diols. The fillers may be one or more reinforcing fillers, non-reinforcing fillers (sometimes also referred as “semi-reinforcing fillers”), or mixtures thereof.

The fillers E optionally provided are preferably minerals. They may in particular be siliceous. Siliceous materials can act as reinforcing or semi-reinforcing filler. Reinforcing siliceous fillers are selected from colloidal silicas, combustion and precipitated silica powders, or mixtures thereof. These powders have an average particle size that is generally less than 0.1 µm (micrometers) and a BET specific surface area greater than 30 m²/g, preferably between 30 and 350 m²/g. Semi-reinforcing siliceous fillers such as diatomaceous earth or crushed quartz may also be used. For non-siliceous mineral materials, these can serve as semi-reinforcing mineral filler. Examples of these non-siliceous fillers which can be used alone or in combination are carbon black, titanium dioxide, aluminum oxide, hydrated alumina, expanded vermiculite, unexpanded vermiculite, calcium carbonate optionally surface treated by fatty acids, zinc oxide, mica, talc, iron oxide, barium sulfate, and slaked lime. These fillers have a particle size generally comprised between 0.001 and 300 µm (micrometers) and a BET surface area of less than 100 m/g. In practice, but this is non-limiting, the fillers used may be a mixture of quartz and silica. The fillers may be treated with any suitable product

Examples of cure rate controller G, which are also known as inhibitor, designed to slow the cure of the compounded silicone if needed. Cure rate controllers are well known in the art and examples of such materials can be found in U.S. Pat.. U.S. Pat. 3,923,705 refers to the use of vinyl contained cyclic siloxanes. U.S. Pat. 3,445,420 describes the use of acetylenic alcohols. U.S Pat. 3,188,299 shows the effectiveness of heterocyclic amines. U.S. Pat. 4,256,870 describes alkyl maleates used to control cure. Olefinic siloxanes can also be used as described in U.S. Pat. 3,989,667. Polydiorganosiloxanes containing vinyl radicals have also been used and this art can be seen in U.S. Pat. 3.498,945, 4,256,870, and 4,347, 346. Preferred inhibitors for this composition are methylvinylcyclosiloxanes, 3-methyl-1-butyn-3-ol, and 1-ethynyl-1-cyclohexanol with the most preferred being the 1,3,5,7-tetramethyl-1,3,5,7-tetravinyl-cyclotetrasiloxane in amounts from 0.002% to 1.00% of the silicone compound depending on the cure rate desired.

The preferred cure rate controller G is chosen among:
1,3,5,7-tetramethyl-1,3,5,7-tetravinyl-cyclotetrasiloxane.
3-methyl-1-butyn-3-ol, or
1-ethynyl-1-cyclohexanol (ECH).

To obtain a longer “gel time” (also known as working time or “pot life”), the quantity of the cure rate controller G is adjusted to reach the desired “gel time”. The concentration of the catalyst inhibitor in the present silicone composition is sufficient to retard curing of the composition at ambient temperature without preventing or excessively prolonging cure at elevated temperatures. This concentration will vary widely depending on the particular inhibitor used, the nature and concentration of the hydrosilylation catalyst, and the nature of the organohydrogenopolysiloxane. Inhibitor concentrations as low as one mole of inhibitor per mole of platinum group metal will in some instances yield a satisfactory storage stability and cure rate. In other instances, inhibitor concentrations of up to 500 or more moles of inhibitor per mole of platinum group metal may be required. The optimum concentration for a particular inhibitor in a given silicone composition can be readily determined by routine experimentation.

Examples of an additive H includes flame retardants, softeners, hardeners, tackifiers, nucleating agents, colorants, pigments, conservatives, rheology modifiers, UV-stabilizers, thixotropic agents, surface additives, flow additives, nanoparticles, antioxidants, toughening agents, thermally insulating particles, electrically conducting particles such as carbon black, graphene, iron, copper, single- and multi-walled carbon nanotubes (SWT, MWT), aluminum, nickel, silver, metallized glass, lead, zinc and alloys, electrically insulating particles, and any combinations or mixtures thereof.

Silicone resins are well known and commercially available branched organopolysiloxane oligomers or polymers. In their structure, they have at least two different repeat units selected from those of formula R₃SiO_{½} (unit M), R₂SiO_{2/2} (unit D), RSiO_{3/2} (unit T), and SiO_{4/2} (unit Q), at least one of these units being a T or Q unit. The R radicals are identical or different and are selected from the radicals: linear or branched C₁ to C₆ alkyl, hydroxyl, phenyl, 3,3,3-trifluoropropyl. Examples of alkyl radicals include methyl, ethyl, isopropyl, tert-butyl, and n-hexyl radicals. Examples of branched oligomers or organopolysiloxane polymers include MQ resins, MDQ resins, TD resins, and MDT resins.

In an embodiment, it may be useful to include silicone resins which may react with reactive components of the curable silicone composition X.

For example, the curable silicone composition may contain an organosilicon resin bearing at least one hydroxy or alkoxy group, functional groups which are either condensable or condensable or hydrolyzable, which comprise at least two different siloxyl units selected from those of formula M, D, T, and Q with:
the siloxyl unit M = (R⁰)₃SiO_{½},
the siloxyl unit D = (R⁰)₂SiO_{2/2},
the siloxyl unit T = R⁰SiO_{3/2}, and
the siloxyl unit Q = SiO_{4/2};
formulas in which R⁰ represents a monovalent hydrocarbon functional group having from 1 to 40 carbon atoms and preferably from 1 to 20 carbon atoms, or an OR‴ group where R‴ = H or an alkyl radical having from 1 to 40 carbon atoms and preferably from 1 to 20 carbon atoms;

with the condition that the resins comprise at least one T or Q unit.

Said resin preferably has a weight percent of hydroxy or alkoxy substituents that is comprised between 0.1 and 10% by weight relative to the weight of the resin, and preferably a weight percent of hydroxy or alkoxy substituents that is comprised between 0.2 and 5% by weight relative to the weight of the resin. Organosilicon resins generally have about 0.001 to 1.5 OH (hydroxyl group) and/or alkoxyl groups per silicon atom. These organosilicon resins are generally prepared by co-hydrolysis and co-condensation of chlorosilanes such as those having the formulas (R¹⁹)₃SiCl, (R¹⁹)₂Si(Cl)₂, R¹⁹Si(Cl)₃, or Si(Cl)₄, the R¹⁹ radicals being identical or different and generally selected from linear or branched C₁ to C₆ alkyl, phenyl, and 3,3,3-trifluoropropyl radicals. Examples of R¹⁹ radicals of the alkyl type include in particular a methyl, an ethyl, an isopropyl, a tert-butyl, and an n-hexyl. Examples of a resin include silicone resins of the following types: T^{(OH)}, DT^{(OH)}, DQ^{(OH)}, DT^{(OH)}, MQ^{(OH)}, MDT^{(OH)}, MDQ^{(OH)}, or mixtures thereof.

Other examples of silicone resins which may react with reactive components of the curable silicone composition X include silicone resins comprising at least one vinyl radical. For example, they may be selected from the group consisting of the following silicone resins:
MD^{Vi}Q where vinyl groups are included in the D units,
MD^{Vi}TQ where vinyl groups are included in the D units,
MM^{Vi}Q where vinyl groups are included in a portion of the M units,
MM^{Vi}TQ where vinyl groups are included in a portion of the M units,
MM^{Vi}DD^{Vi}Q where vinyl groups are included in a portion of the M and D units,
and mixtures thereof, with:
M^{Vi} = siloxyl unit of formula (R)₂(vinyl)SiO_{½}
D^{Vi} = siloxyl unit of formula (R)(vinyl)SiO_{2/2}
T = siloxyl unit of formula (R)SiO_{3/2}
Q = siloxyl unit of formula SiO_{4/2}
M = siloxyl unit of formula (R)₃SiO_{½}
D = siloxyl unit of formula (R)₂SiO_{2/2}
and the R functional groups, which are identical or different, are monovalent hydrocarbon groups selected from: alkyl groups having from 1 to 8 carbon atoms inclusive, such as methyl, ethyl, propyl, and 3,3,3-trifluoropropyl groups, and aryl groups such as xylyl, tolyl, and phenyl. Preferably, the R functional groups are methyl groups.

Other examples of silicone resins which may react with reactive components of the curable silicone composition X include the following silicone resins:
M′Q wherein the hydrogen atoms bonded to silicon atoms are carried by M siloxyl unit,
MM′Q where the hydrogen atoms bonded to silicon atoms are carried by a portion of the M siloxy units,
MD′Q where the hydrogen atoms bonded to silicon atoms are carried by the siloxyl unit,
MDD′Q where the hydrogen atoms bonded to silicon atoms are carried by a portion of the siloxyl units,
MM′TQ where the hydrogen atoms are included in a portion of the M siloxyl units,
MM′DD′Q where the hydrogen atoms are included in a portion of the M and D siloxyl units,
and mixtures thereof, with:
M, D, T, and Q as defined previously
M′ = siloxyl unit of formula R₂HSiO_{½}
D′ = siloxyl unit of formula RHSiO_{2/2}
and the R functional groups, which are identical or different, are monovalent hydrocarbon groups selected from the alkyl groups having from 1 to 8 carbon atoms inclusive, such as methyl, ethyl, propyl, and 3,3,3-trifluoropropyl groups. Preferably, the R groups are methyl groups.

In another preferred embodiment, the temperature for allowing the curable silicone X to cure is from 20° C. to 180° C.

Another object of the invention concerns a silicone foam which is air foamed and syntactic and which is prepared according to the process of the invention described above and which has a thermal conductivity.

According to another advantageous aspect of the disclosure, the silicone foam which is air foamed and syntactic and which is prepared according to the process of the invention described above and has a thermal conductivity in a range from 0.005 to 1 W/(m·K), from 0.01 to 1 W/(m·K), from 0.02 to 0.5 W/(m·K), from 0.02 to 0.25 W/(m·K) or from 0.02 to 0.10 W/(m·K).

According to another advantageous aspect of the disclosure, the silicone foam according to the invention has a density in a range from 0.1 to 1.0 g/cm³, from 0.2 to 0.8 g/cm³ or even from 0.2 to 0.7 g/cm³.

Another object of the invention concerns also an article comprising the silicone foam which is air foamed and syntactic according to the invention and as described above.

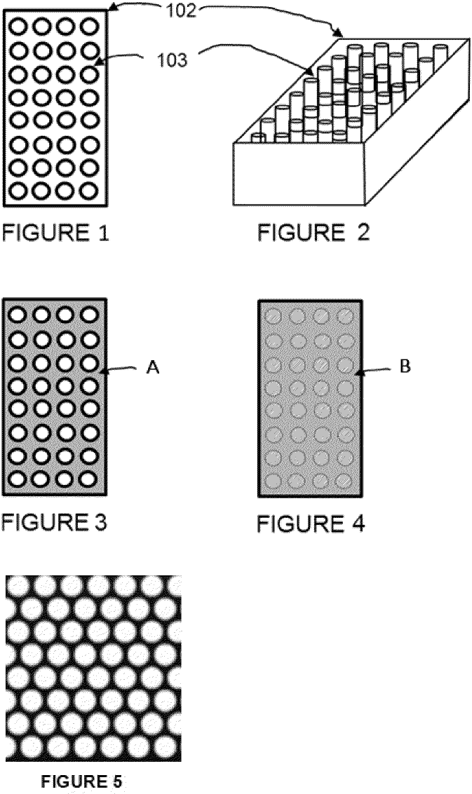

FIG. 1 provides a top view of a secondary battery pack without the enclosure top panel 104 with an array of battery cells 103 inside an enclosure bottom panel 102 (the electrical connections of the battery cells are not shown).

FIG. 2 provides a perspective view of a secondary battery pack with an array of battery cells 103 placed inside the enclosure bottom panel 102 (the electrical connections of the battery cells are not shown).

FIG. 3 provides a top view of batteries in a secondary battery pack with the silicone syntactic foam A (air-foamed according to the invention and quoted as component A in the FIG. 3) filling the space between the array of battery cells 103 and the remaining space in the enclosure bottom panel 102 (the electrical connections of the battery cells are not shown).

FIG. 4 provides a top view of an array of battery cells 103 in a secondary battery pack covered with the with the silicone syntactic foam A (air-foamed according to the invention and quoted as component B in the FIG. 4) according to the invention and with said silicone syntactic foam A filling the space between batteries and the remaining space in the pack (the electrical connections of the battery cells are not shown).

FIG. 5 provides a top view of an array of battery cells 103 which is designed to yield a honeycomb like array of battery cells 103 (the electrical connections of the battery cells are not shown) covered with said silicone syntactic foam according to the invention.

FIGS. 1 and 2 show that battery cells 103 can be very close together in the enclosure bottom panel 102. In one embodiment of the invention the composition X according to the invention and precursor of the material A is poured into the bottom panel enclosure 102 after the array of battery cells have been placed and installed (FIG. 3, 104) and yield to silicone syntactic foam which is also air-foamed when it is cured according to the invention (FIG. 4. 105).

In a preferred embodiment, the article is a secondary battery pack comprising
a battery pack enclosure 101 composed of an enclosure top panel 104 and an enclosure bottom panel 102 which when sealed to each other provide a substantially airtight battery pack enclosure 101,
at least one array of battery cells 103 within said enclosure bottom panel 102 which are electrically connected to one another and are arranged in an upright manner such that axes of the cells are parallel to each other,
a silicone foam which is air foamed and syntactic according to the invention and as described above and which fills partially or fully the open space of said battery pack enclosure 101 and/or fills partially or fully the open space within said array of battery cells 103 and/or covers partially or totally said battery cells 103.

In a preferred embodiment, the array of battery cells 103 are electrically connected to one another and are arranged in an upright manner such that axes of the cells are parallel to each other, are separated from each other by a gap, and further contains a plurality of silicone foam layers which are air foamed and syntactic according to the invention and as described above and which are positioned in the gap between the secondary battery cells 103.

In another embodiment, the article is a secondary battery pack comprising:
at least one battery module casing 102 in which is disposed a plurality of secondary battery cells 103 which are electrically connected to one another,
a silicone foam which is air foamed and syntactic according to the invention and as described above, and said silicone rubber syntactic foam fills partially or fully the open space of said battery module casing 102 and/or covering partially or totally said battery cells 103 and/or covering partially or totally said module casing 102, and
optionally a lid covering the battery module casing 102.

In a preferred embodiment, the plurality of secondary battery cells 103 are electrically connected to one another are separated from each other by a gap, and further contains a plurality of silicone foam layers which are air foamed and syntactic according to the invention and as described above and which are positioned in the gap between the secondary battery cells 103.

In a preferred embodiment, the silicone foam layers are in the form of sheets of 0.5 to 50 mm thickness, preferably of 1 to 25 mm thickness, and even more preferably of 1 to 15 mm thickness.

In another preferred embodiment, the battery cells 103 are of lithium-ion type.

According to another preferred embodiment, the secondary battery pack according to invention, further comprising a plurality of heat dissipation members which are disposed at two or more interfaces between the battery cells or underneath the array of battery cells 103, and at least one heat exchange member integrally interconnecting the heat dissipation members, whereby heat generated from the battery cells during the charge and discharge of the battery cells is removed by the heat exchange member. It allows for cooling of the battery cells with higher efficiency than conventional cooling systems even with no spaces between the battery cells or with very small spaces between the battery cells, thereby maximizing heat dissipation efficiency of the secondary battery pack.

According to another preferred embodiment, the heat dissipation members according to the invention are made of a thermally conductive material exhibiting high thermal conductivity and the heat exchange member is provided with one or more coolant channels for allowing a coolant such as a liquid or a gas to flow there.

Heat dissipation members according to the invention are not particularly restricted as long as each of the heat dissipation members is made of a thermally conductive material such as a metal plate exhibiting high thermal conductivity.

Preferably, the heat exchange member is provided with one or more coolant channels for allowing a coolant to flow there through. For example, coolant channels for allowing a liquid coolant, such as water, to flow there through may be formed in the heat exchange member, thereby providing an excellent cooling effect with high reliability as compared with a conventional air-cooling structure.

According to another preferred embodiment, the secondary battery pack according to the invention, further comprising a coolant inlet manifold, a coolant outlet manifold and a plurality of thermal exchange tubes as heat dissipation members and extending between the inlet and outlet manifolds, said thermal exchange tubes are disposed at one or more interfaces between the battery cells and/or underneath the array of battery cells 103 and have a coolant passing through to exchange heat generated from the battery cells during the charge and discharge of the battery cells.

According to another preferred embodiment, the battery cells 103 are cylindrical cells and are arranged in a plurality of cell rows to yield an array of battery cells 103 and preferably said array is designed to yield a honeycomb like array of battery cells.

In a preferred embodiment, the secondary battery pack further contains a honeycomb like structure in which the battery cells 103 are inserted and held to form an array of battery cells 103.

The battery pack enclosure 101 composed of an enclosure top panel 104 and an enclosure bottom panel 102 which when sealed to each other provide a substantially airtight battery pack enclosure 101. It is configured to hold a plurality of battery cells. The secondary battery pack may further include a ballistic shield mounted under the electric vehicle and interposed between the battery pack enclosure and the driving surface. The ballistic shield may be fabricated from aluminum, an aluminum alloy, steel, fiberglass, a carbon fiber/epoxy composite, and/or plastic.

The battery pack enclosure 101 may be substantially airtight and may be fabricated from an aluminum, aluminum alloy or steel.

According to a preferred embodiment, the secondary battery pack according to the invention is located within a vehicle.

It is understood that the term “vehicle” as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

In another preferred embodiment, the secondary battery pack according to the invention is located in an automotive motor vehicle.

In another embodiment, the secondary battery pack according to the invention is located in an all-electric vehicle (EV), a plug-in hybrid vehicle (PHEV), a hybrid vehicle (HEV).

In another embodiment, the article according to the invention is located in a vehicle, an aircraft, a boat, a ship, a train, a wall unit or a stationary energy storage.

Another object of the invention concerns an article comprising a substrate and at least one coated layer composed of the silicone foam according to the invention which is air foamed and syntactic.

Another object of the invention concerns the use of the article according to the invention and as described above in marine applications, aerospace applications, aeronautic applications, ground transportation vehicle applications, remotely operated underwater vehicles or autonomous underwater vehicles.

Another object of the invention concerns a recycling method comprising the steps of:
a) providing an article according to the invention and as described above,
b) removing the silicone foam which is air foamed and syntactic, and
c) recycling or re-using said article and/or components of said article.

The recycling method according to the invention is an adapted response to the emerging need for large OEMs to have either rework capability or a process for recovering key components for many of their devices.

Indeed, when the article is a typical EV lithium-ion battery pack it has a useful first life of around 250,000 km and when it loses from 15% to 20% of its initial capacity it becomes unfit for traction as the lower capacity of battery affects acceleration, range and regeneration capabilities of the vehicle. The possibility to reuse the batteries at the end of their automotive lifecycle for stationary energy storage for example as part of a smart grid to provide energy storage systems (ESS) for load leveling, residential or commercial power, is a key step toward circular economy. The potential impact of battery reuse on life cycle greenhouse gas emissions and energy usage of the battery in first and second uses is also a key advantage linked to the use of the recycling method according to the invention.

By using the recycling method according to the invention, the silicone syntactic foam according to the invention may-be easily and cleanly peeled-off from the battery pack allowing collecting and via testing infrastructure selecting batteries which have between 80-85% of their original capacity for re-use purpose, and the others for recycling purpose to recover key raw materials such as cobalt, lithium, copper, graphite, nickel, aluminum, and manganese.

Other advantages provided by the present invention will become apparent from the following illustrative examples.

### EXAMPLES

### I) Definition of the Components

Organopolysiloxane A1 = polydimethylsiloxane with dimethylvinylsilyl end-units with a viscosity at 25° C. ranging from 80 mPa.s to 120 mPa.s;
   Organopolysiloxane A2 = polydimethylsiloxane with dimethylvinylsilyl end-units with a viscosity at 25° C. ranging from 500 mPa.s to 650 mPa.s;
Organopolysiloxane B1 (CE) as chain extender = polydimethylsiloxane with dimethylsilylhydride end-units with a viscosity at 25° C. ranging from 7 mPa.s to 10 mPa.s and formula: M′DₓM′ In which:
   D is a siloxy unit of formula (CH₃)₂SiO_{2/2}
   M′ is a siloxy unit of formula (CH₃)₂(H)SiO_{½}
   and x is an integer ranging from 8 to 11;
Organopolysiloxane B2 (XL) as crosslinker, with a viscosity at 25° C. ranging from 18 mPa.s to 26 mPa.s, over 10 SiH reactive groups are present (in average from 16 to 18 SiH reactive groups): poly(methylhydrogeno) (dimethyl)siloxane with SiH groups in-chain and end-chain (α/ω),
Hollow glass microspheres filler D1: 3M™ Glass Bubbles Series S15, sold by 3 M Company, Particle Size (50%) microns by volume = 55 microns, Isostatic Crush Strength: Test Pressure 300 psi (2.07 MPa.), True Density (g/cc) = 0.15.
Hollow glass microspheres filler D2: 3M™ Glass Bubbles Series K25, sold by 3 M Company, (Particle Size (50%) microns by volume = 55 microns, Isostatic Crush Strength Test Pressure 750 psi, True Density (g/cc) = 0.25.
Hollow glass microspheres filler D3: 3M™ Glass Bubbles Series H20/1000 sold by 3 M Company, (Particle Size (50%) microns by volume = microns, Isostatic Crush Strength Test Pressure 1,000 psi, True Density (g/cc) = 0.2.
Hollow glass microspheres filler D4: 3M™ Glass Bubbles Series XLD/3000 sold by 3 M Company, (Particle Size (50%) microns by volume = microns, Isostatic Crush Strength Test Pressure 3000 psi, True Density (g/cc) = 0.68.
Hollow glass microspheres filler D7: 3M™ Glass Bubbles K20HS hollow microspheres made of soda-lime borosilicate glass with a true density of 0.20 g/cm³ and an isostatic crush strength of 750 psi / 52 bar.
Filler D5: MIN-U-SIL^{®}10, fine ground silica (median size 3.4 microns) supplied by US Silica.
Filler D6: Spheriglass^{®}: solid glass beads (soda-lime glass in a microbead form (Spheriglass® A-Glass 3000 sold by Potter Industries Inc).
Filler D7: Cenospheres ES106 supplied by Cenostar.
Cure rate controller G1: 1,3,5,7-tetramethyl-1,3,5,7-tetravinyl-cyclotetrasiloxane.
Cure rate controller G2: 1-Ethynyl-1-cyclohexanol (ECH).
Cure rate controller G3-MB: 90% by weight of Organopolysiloxane A1 and 10% by weight of cure rate controller G2
Catalyst C: 10% platinum as Karstedt catalyst in 350 cS dimethylvinyldimer, sold by Johnson Matthey Company.
Catalyst C-MB: 98% by weight of Organopolysiloxane A1 and 2% by weight of Catalyst C.

The densities are quoted as gram per cubic centimeter (g/cc).

The gel time corresponds to the time for the reaction mixture to gel and is measured at room temperature (20° C.) with a Rotational Gel timer. The procedure is as followed:

1. The formulations were prepared by mixing the corresponding parts A and B in aluminum cups.

2. As soon as the mixing (part B is added to part A) was done the timer of the rotational gel timer is started. The resulting mixture is hand mixed with a spatula for 90 seconds.

3. The alumina cup containing the mixture is then placed into the rotational gel timer and is secured with a C-Clamp.

4. A wire stirrer is immediately installed (during this operation the timer is stopped and is restarted immediately after it is finished).

5. The mixture is stirred, and the gel time is recorded when the Gel timer stops spinning.

### Example 1: Effect of Filler’s Type on Foaming Under Reduced Pressure

TABLE 1

Formulations (1:1 mix ratio by weight of parts A and B for each formulation).

| | Formulation 1 used for Invention | Formulation 2 used as comparative | Formulation 3 used as comparative |
|---|---|---|---|
| Part A | Percent by weight | Percent by weight | Percent by weight |
| Organopolysiloxane A1 | 83.69 | 83.69 | 83.69 |
| Catalyst C | 0.0335 | 0.0335 | 0.0335 |
| Filler D2 | 16.28 | 0 | 0 |
| Filler D5 | 0 | 16.28 | 0 |
| Filler D6 | 0 | 0 | 16.28 |
| Total | 100.00 | 100.00 | 100.00 |
| Part B | Percent by weight | Percent by weight | Percent by weight |
| Organopolysiloxane A1 | 66.76 | 66.76 | 66.76 |
| Organopolysiloxane B1 (CE) | 14.94 | 14.94 | 14.94 |
| Organopolysiloxane B2 (XL) | 2.03 | 2.03 | 2.03 |
| Filler D2 | 16.28 | 0 | 0 |
| Filler D5 | 0 | 16.28 | 0 |
| Filler D6 | 0 | 0 | 16.28 |
| Cure rate controller G2: | 0.001 | 0.001 | 0.001 |
| Total | 100.00 | 100.00 | 100.00 |
| Density of the cured silicone syntactic foam (g/cc) | 0.41 | 0.55 | Not measured |
| The cured silicone syntactic foam is also air foamed | yes | no | no |

Formulations 1, 2 and 3 were each prepared in a container by gently mixing (hand mixing with a spatula) the corresponding parts A and B (1:1 mix ratio by weight) for 30 s and then each container was placed under a reduced atmospheric pressure (maintained within a range of 150 to 200 mbar) and curing occurred at room temperature [20° C.].
Formulation 1 (used according to the invention) yielded to a silicone syntactic foam which is also air-foamed and exhibits a homogeneous cell size distribution and a good foam structure (density=0.407, Thermal conductivity: 0.068 W/mK.
Formulation 2 (used as comparative) which comprises a fine ground silica filler (MIN-U-SIL® 10) did not yield to an air-foamed structure under the same curing conditions as of Formulation 1.
Formulation 3 (used as comparative) which comprises solid glass beads did not yield to an air-foamed structure under the same curing conditions as of Formulation 1.

### Example 2: Impact of Reduced Pressure on Foaming

TABLE 2

Formulation 1 (1:1 mix ratio by weight of parts A and B for each formulation).

| | Reduced atmospheric pressure applied was maintained with a specific range (mbar) | Density of the cured silicone syntactic foam which is also air foamed | Quality of the cured syntactic foam which is also air foamed |
|---|---|---|---|
| Test 3 | from 650 to 700 | 0.59 | 1 |
| Test 4 | from 480 to 530 | 0.57 | 2 |
| Test 5 | from 300 to 350 | 0.58 | 2 |
| Test 6 | from 150 to 200 | 0.54 | 3 |

Formulation 1 was prepared in a container by gently mixing (hand mixing with a spatula) the corresponding parts A and B (1:1 mix ratio by weight) and then the resulting formulation was placed under different reduced atmospheric pressure. The vacuum was started at a time which corresponds to 30% of the gel time of formulation 1 and curing occurred at room temperature [20° C.]. The quality of the resulting silicone syntactic foams which were also air foamed was evaluated according to homogeneous cell size distribution and foam structure. The foams were classified according to the following quality rating:
poor quality = 0
good quality = 1
very good quality = 2
Excellent quality = 3

Note: In terms of rating: “excellent quality” stands for a higher foam quality compared to “very good quality”.

### Example 3: Impact of Timing (% of Gel Time) of When a Reduced Pressure is Applied

TABLE 3

Formulation 1 (1:1 mix ratio by weight of parts A and B) Impact of timing (% of gel time) of when a reduced pressure is applied.

| Test number | Time at which the reduced pressure was applied (% of the gel time of Formulation 1) | Density of the cured silicone syntactic foam which is also air foamed | Quality of the cured syntactic foam which is also air foamed |
|---|---|---|---|
| Test 7 | 30 | 0.56 | 1 |
| Test 8 | 40 | 0.63 | 2 |
| Test 9 | 50 | 0.45 | 3 |
| Test 10 | 55 | 0.24 | 5 |
| Test 11 | 60 | 0.28 | 4 |

Formulation 1 was prepared in a container by gently mixing (hand mixing with a spatula) the corresponding parts A and B (1:1 mix ratio by weight). A reduced atmospheric pressure was applied (value within a range of 150 to 200 mbar) at various timing expressed as % of the gel time of formulation 1 and curing occurred at room temperature [20° C.]. The quality of each resulting silicone syntactic foams which were also air foamed was evaluated according to homogeneous cell size distribution and foam structure. The foams were classified according to the following quality rating:
Poor quality = 0
Medium quality= 1
Good quality = 2
Very good quality = 3
Excellent quality = 4
Outstanding = 5
Note: In terms of rating: “excellent quality” stands for a higher foam quality compared to “very good quality” and “outstanding” stands for a higher foam quality compared to “excellent quality”. A highest number corresponds to a higher quality.

Measured gel time is 260 seconds.

### Example 4: Effect of % by Weight of Hollow Glass Microspheres Loading

TABLE 4

Formulations (1:1 mix ratio by weight of parts A and B)

| | Formulation 1 used for Invention | Formulation 4 used for Invention | Formulation 5 used for Invention |
|---|---|---|---|
| Part A | Percent by weight | Percent by weight | Percent by weight |
| Organopolysiloxane A1 | 83.69 | 87.97 | 89.97 |
| Catalyst C | 0.033 | 0.035 | 0.036 |
| Filler D2 | 16.28 | 12.00 | 10 |
| Total | 100.00 | 100.00 | 100 |
| Part B | Percent by weight | Percent by weight | Percent by weight |
| Organopolysiloxane A1 | 66.76 | 68.54 | 70.10 |
| Organopolysiloxane B1 (CE) | 14.94 | 17.54 | 17.94 |
| Organopolysiloxane B2 (XL) | 2.03 | 1.91 | 1.96 |
| Filler D2 | 16.28 | 12.00 | 10 |
| Cure rate controller G2: | 0.001 | 0.001 | 0.001 |
| Total | 100.00 | 100.00 | 100.00 |
| Gel Time (seconds) | 316 | 306 | 267 |

Formulations described in Table 4 were prepared in a container by gently mixing (hand mixing with a spatula) the corresponding parts A and B (1:1 mix ratio by weight). A reduced atmospheric pressure was applied (value within a range of 150 to 200 mbar) at various timing expressed as % of the gel time of the formulations and curing occurred at room temperature [20° C.] for 8 minutes. The quality of each resulting silicone syntactic foams which were also air foamed was evaluated according to homogeneous cell size distribution and foam structure. The foams were classified according to the following quality rating:
Poor quality = 0
Medium quality= 1
Good quality = 2
Very good quality = 3
Excellent quality = 4
Outstanding = 5
Note: In terms of rating: “excellent quality” stands for a higher foam quality compared to “very good quality” and “outstanding” stands for a higher foam quality compared to “excellent quality”. A highest number corresponds to a higher quality.

The results are described in Table 5 below.

TABLE 5

Formulations (1:1 mix ratio by weight of parts A and B)

| Formulation | Test number | Time at which the reduced pressure was applied (% of the gel time of Formulation 1) | Quality of the cured syntactic foam which is also air foamed |
|---|---|---|---|
| 1 | Test 7 | 30 | 1 |
| 1 | Test 8 | 40 | 2 |
| 1 | Test 9 | 50 | 3 |
| 1 | Test 10 | 55 | 5 |
| 1 | Test 11 | 60 | 4 |
| 4 | Test 12 | 30 | 1 |
| 4 | Test 13 | 40 | 2 |
| 4 | Test 14 | 50 | 3 |
| 4 | Test 15 | 55 | 3 |
| 4 | Test 16 | 60 | 3 |
| 5 | Test 17 | 30 | 1 |
| 5 | Test 18 | 40 | 1 |
| 5 | Test 19 | 50 | 1 |
| 5 | Test 20 | 55 | 2 |
| 5 | Test 21 | 60 | 2 |

### Example 5: Silicone Syntactic Foams Which Are Also Air Foamed According to the Invention

TABLE 6

Formulations (1:1 mix ratio by weight of parts A and B)

| | Formulation 1 Invention | Formulation 6 Invention | Formulation 7 Invention | Formulation 8 Invention | Formulation 9 Invention |
|---|---|---|---|---|---|
| Part A | % by weight | % by weight | % by weight | % by weight | % by weight |
| Organopolysiloxane A1 | 83.69 | 83.69 | 83.69 | 83.69 | 83.69 |
| Catalyst C | 0.033 | 0.033 | 0.033 | 0.033 | 0.033 |
| Filler D2 | 16.28 | 0 | 0 | 0 | 0 |
| Filler D1 | 0 | 16.28 | 0 | 0 | 0 |
| Filler D3: H20/1000 | 0 | 0 | 16.28 | 0 | 0 |
| Filler D4: XLD/3000 | 0 | 0 | 0 | 16.28 | 0 |
| Filler D7: K20HS | 0 | 0 | 0 | 0 | 16.28 |
| Total | 100.00 | 100.00 | 100.00 | 100.00 | 100 |
| Part B | % by weight | % by weight | % by weight | % by weight | % by weight |
| Organopolysiloxane A1 | 66.76 | 66.76 | 66.76 | 66.76 | 66.76 |
| Organopolysiloxane B1 (CE) | 14.94 | 14.94 | 14.94 | 14.94 | 14.94 |
| Organopolysiloxane B2 (XL) | 2.03 | 2.03 | 2.03 | 2.03 | 2.03 |
| Filler D2 | 16.28 | 0 | 0 | 0 | 0 |
| Filler D1 | 0 | 16.28 | 0 | 0 | 0 |
| Filler D3 | 0 | 0 | 16.28 | 0 | 0 |
| Filler D4 | 0 | 0 | 0 | 16.28 | 0 |
| Filler D7 | 0 | 0 | 0 | 0 | 16.28 |
| Cure rate controller G2: | 0.001 | 0.001 | 0.001 | 0.001 | 0.001 |
| Total | 100.00 | 100.00 | 100.00 | 100.00 | 100.00 |
| Quality of the cured syntactic foam which is also air foamed | 5 | 5 | 5 | 5 | 5 |

Formulations described in Table 6 were prepared in a container by gently mixing (hand mixing with a spatula) the corresponding parts A and B (1:1 mix ratio by weight). A reduced atmospheric pressure was applied (value within a range of 150 to 200 mbar) at 55 % of the gel time of the formulations and curing occurred at room temperature [20° C.]. The quality of each resulting silicone syntactic foams which were also air foamed was evaluated according to homogeneous cell size distribution and foam structure. The foams were classified according to the following quality rating:
Poor quality = 0
Medium quality= 1
Good quality = 2
Very good quality = 3
Excellent quality = 4
Outstanding = 5
Note: In terms of rating: “excellent quality” stands for a higher foam quality compared to “very good quality” and “outstanding” stands for a higher foam quality compared to “excellent quality”. A highest number corresponds to a higher quality.

### Example 6: Thermal Conductivity

Formulation 1 was prepared according to the Example 1 to yield a silicone syntactic foam (1) which is air foamed and with a thermal conductivity of 0.068 W/mK.

The same formulation 1 was cured without using the procedure of the invention (no reduced pressure was applied to the curing) to yield a silicone syntactic foam (2) but did not yield to air foaming. The thermal conductivity measured was equal to 0.12 W/mK.

### Example 7: Hollow Ceramic Microspheres

TABLE 7

Formulation 10 (1:1 mix ratio by weight of parts A and B)

| | Formulation 1 used for Invention |
|---|---|
| Part A | Percent by weight |
| Organopolysiloxane A1 | 83.69 |
| Catalyst C | 0.0335 |
| Filler D7 | 16.28 |
| Total | 100.00 |
| Part B | Percent by weight |
| Organopolysiloxane A1 | 66.76 |
| Organopolysiloxane B1 (CE) | 14.94 |
| Organopolysiloxane B2 (XL) | 2.03 |
| Filler D7 | 16.28 |
| Cure rate controller G2: | 0.001 |
| Total | 100.00 |
| The cured silicone syntactic foam is also air foamed | yes |
| Evaluation of the quality of the resulting foam | 3 |

Formulation 10 described in Table 7 was prepared in a container by gently mixing (hand mixing with a spatula) the corresponding parts A and B (1:1 mix ratio by weight). A reduced atmospheric pressure was applied (value within a range of 150 to 200 mbar) at 55 % of the gel time of the formulations and curing occurred at room temperature [20° C.] for 8 minutes. The quality of the silicone syntactic foams which was also air foamed was evaluated according to homogeneous cell size distribution and foam structure. The foams was classified according to the following quality rating:
Poor quality = 0
Medium quality= 1
Good quality = 2
Very good quality = 3
Excellent quality = 4
Outstanding = 5
Note: In terms of rating: “excellent quality” stands for a higher foam quality compared to “very good quality” and “outstanding” stands for a higher foam quality compared to “excellent quality”. A highest number corresponds to a higher quality.

1. A method for preparing a silicone foam which is air foamed and syntactic comprising the following:
a) preparing a curable silicone composition X comprising hollow microspheres D1, and
b) allowing the curable silicone composition X to cure under a reduced atmospheric pressure to obtain a silicone foam which is air foamed and syntactic.

2. A method according to claim 1 wherein the hollow microspheres D1 are hollow glass microspheres D, and optionally are hollow borosilicate glass microspheres.

3. A method according to claim 1 in which the reduced atmospheric pressure applied is below 700 mbar, optionally from 700 to 100 mbar, and optionally from 530 to 150 mbar.

4. A method according to claim 1 in which the reduced atmospheric pressure is applied before the curable silicone composition X is fully cured and at a time which is at least 10% of gel time of the curable silicone composition X, optionally at a time which is at least 30% of gel time of the curable silicone composition X, optionally at a time which is from 30% to 70% of gel time of the curable silicone composition X, and optionally at a time which is from 45% to 65% of gel time of the curable silicone composition X.

5. A method according to claim 1 wherein for 100 parts by weight of the curable silicone composition X comprising from 1 part to 60 parts by weight, optionally from 5 parts to 40 parts by weight, optionally from 5 parts to 30 parts by weight and optionally from 5 parts to 20 parts by weight of hollow microspheres D1.

6. A method according to claim 2 wherein the hollow glass microspheres D have a true density ranging from 0.10 gram per cubic centimeter to 0.75 gram per cubic centimeter.

7. A method according to claim 1 wherein the curable silicone composition X comprises:
a) at least one organopolysiloxane A having at least two silicon-bonded alkenyl groups per molecule, linear or branched and having from 2 to 8 carbon atoms,
b) at least one organohydrogensiloxane B having at least two silicon-bonded hydrogen atoms per molecule and preferably at least three silicon-bonded hydrogen atoms per molecule;
c) at least one hydrosilylation catalyst C,
d) hollow glass microspheres D, and optionally hollow borosilicate glass microspheres,
e) optionally at least one filler E,
f) optionally at least one cure rate controller G which slows the curing rate,
g) optionally at least one additive H, and
i) optionally at least one silicone resin I.

8. A method according to claim 7 wherein the at least one organohydrogensiloxane B is a mixture of at least one silicon compound CE comprising two telechelic hydrogen atoms bonded to silicon per molecule with no pendent hydrogen atoms bonded to silicon per molecule and at least one silicon compound XL comprising at least three hydrogen atoms bonded to silicon per molecule.

9. A method according to claim 7 wherein components of the curable silicone composition X are chosen so that viscosity thereof is between 500 mPa.s to 20,000 mPa.s and optionally between 500 mPa.s to 10,000 mPa.s.

10. A method according to claim 1 wherein the temperature for allowing the curable silicone X to cure is from 20° C. to 180° C.

11. A silicone foam which is air foamed and syntactic prepared according to claim 1.

12. An article comprising the silicone foam which is air foamed and syntactic according to claim 11.

13. An article according to claim 12 which is a secondary battery pack comprising
a battery pack enclosure composed of an enclosure top panel and an enclosure bottom panel which when sealed to each other provide a substantially airtight battery pack enclosure,
at least one array of battery cells within said enclosure bottom panel which are electrically connected to one another and are arranged in an upright manner such that axes of the cells are parallel to each other,
a silicone foam which is air foamed and syntactic and which fills partially or fully the open space of said battery pack enclosure and/or fills partially or fully the open space within said array of battery cells and/or covers partially or totally said battery cells.

14. An article according to claim 12 which is a secondary battery pack wherein an array of battery cells, which are electrically connected to one another and are arranged in an upright manner such that axes of the cells are parallel to each other, are separated from each other by a gap, and further comprises a plurality of silicone foam layers which are air foamed and syntactic and which are positioned in a gap between secondary battery cells.

15. An article according to claim 12 which is a secondary battery pack comprising:
at least one battery module casing in which is disposed a plurality of secondary battery cells which are electrically connected to one another,
a silicone foam which is air foamed and syntactic, and said silicone foam fills partially or fully an open space of said battery module casing and/or covering partially or totally said battery cells and/or covering partially or totally said module casing, and
optionally a lid covering the battery module casing.

16. An article according to claim 15 which is a secondary battery pack wherein a plurality of secondary battery cells which are electrically connected to one another are separated from each other by a gap, and further comprises a plurality of silicone foam layers which are air foamed and syntactic and which are positioned in the gap between the secondary battery cells.

17. An article according to claim 14 in which silicone foam layers are in the form of sheets of 0.5 to 50 mm thickness, optionally of 1 to 25 mm thickness, and optionally of 1 to 15 mm thickness.

18. An article according to claim 13 wherein said battery cells are of lithium-ion type.

19. An article according to claim 13 wherein the secondary battery cells are in the form of pouch, prismatic or cylindrical shape.

20. An article according to claim 12 wherein said article is located in a vehicle, an aircraft, a boat, a ship, a train, a wall unit or a stationary energy storage.

21. An article according to claim 12 comprising a substrate and at least one coated layer composed of the silicone foam which is air foamed and syntactic.

22. A product comprising the article according to claim 12 in marine applications, aerospace applications, aeronautic applications, ground transportation vehicle applications, remotely operated underwater vehicles or autonomous underwater vehicles.

23. A recycling method comprising:
a) providing an article according to claim 12,
b) removing the silicone foam which is air foamed and syntactic, and
c) recycling or re-using said article and/or components of said article.
